(19) United States
(12) Patent Application Publication
(10) Pub. No.: US 2003/0035363 A1
(43) Pub. Date: Feb. 20, 2003

(54) Optical disc with coaxially alignment of the signal center axis and the hub center axis

(76) Inventors: Michiyoshi Nagashima, Torrance, CA (US); Ross Querubin, Buena Park, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/218,844

(22) Filed: Aug. 13, 2002

Related U.S. Application Data
(60) Provisional application No. 60/312,121, filed on Aug. 14, 2001.
(60) Provisional application No. 60/314,473, filed on Aug. 23, 2001.

(51) Int. Cl. G11B 3/70; G11B 5/84; G11B 7/26

(52) U.S. Cl. 369/282; 369/286

(57) ABSTRACT

An optical disc includes a first substrate having a first central opening, a first signal layer formed on one of the surfaces of the first substrate, a second substrate having a second central opening, a second signal layer formed on one of the surfaces of the second substrate, and a hub having a central longitudinal axis. The first substrate and the first signal layer are designed such that a first central longitudinal axis of the first opening substantially coaxially aligns with a first central longitudinal axis of the first signal layer, and the second substrate and the second signal layer are designed such that a second central longitudinal axis of the second opening substantially coaxially aligns with a second central longitudinal axis of the second signal layer. The first substrate, the second substrate and the hub are bonded together with the result of substantially coaxially alignment of the central longitudinal axis of the first signal layer, the second signal layer and the hub.

### CROSS-REFERENCE TO RELATED APPLICATIONS

This application claims the benefit of the filing date of Provisional Patent Application Serial No. 60/312,121, filed on Aug. 14, 2001, and entitled “Method of Coaxially Aligning the Signal Center Axis with the Hub Center Axis of an Optical Disc”, and Provisional Patent Application Serial No. 60/314,473, filed on Aug. 23, 2001, and entitled “Dual Signal Layer and Thin Substrate Optical Disc and Related Methods.”

### FIELD OF THE INVENTION

This invention relates generally to optical discs, and in particular, a method of coaxially aligning the signal center axis of the optical disc with the hub center axis of the optical disc, and the resulting optical disc.

### BACKGROUND OF THE INVENTION

An optical disc typically consists of a signal layer formed on a disc-shaped substrate having a central opening. The signal layer spirals around the disc-shaped substrate about a center longitudinal axis. In addition, the optical disc typically includes a generally cylindrical and metallic hub situated within the central opening of the disc-shaped substrate. The hub also has a corresponding center longitudinal axis. When the optical disc is properly inserted into a reader, the hub is coaxially mounted to the spindle motor of the reader (i.e. the hub center is substantially concentric with the center of rotation of the motor). In order for the optical disc reader to read the signal layer properly, the signal center axis should be substantially coaxial with the center of rotation of the spindle motor. Therefore, it follows that the signal center axis should be substantially coaxial with the hub center axis.

FIG. 1 illustrates a cross-sectional view of a prior art double-sided optical disc 100. The optical disc 100 consists of a disc-shaped substrate 102 having a central opening 104. An upper signal layer 106a is formed on the upper surface of the substrate 102 and a lower signal layer 106b is formed on the lower surface of the substrate 102. The upper signal layer 106a has an associated signal center longitudinal axis C_{SA} and the lower signal layer 106b has an associated signal center longitudinal axis C_{SB}. The optical disc 100 further consists of an upper hub 108a and a lower hub 108b. The upper and lower hubs 108a-b consists of respective cylindrical portions 110a-b that extend coaxially within the central opening 104 of the substrate 102 and respective lip portions 112a-b that mount on the upper and lower surfaces of the substrate 102, respectively. The upper hub 108a has an associated center longitudinal axis C_{HA} and the lower hub 108b has an associated center longitudinal axis C_{HB}.

As previously discussed, in order for the optical disc reader to properly read the signal layers 106a-b of the optical disc 100, the signal center longitudinal axes C_{SA} and C_{SB} should be substantially coaxial with the hub center longitudinal axes C_{HA} and C_{HB}, respectively. However, in the prior art optical disc 100, the signal center longitudinal axes C_{SA} and C_{SB} do not necessarily coincide with the center longitudinal axis of the disc-shaped substrate 102 or with each other. In addition, the hub center longitudinal axes C_{HA} and C_{HB} do not necessarily coincide with the center longitudinal axes of the disc-shaped substrate 102 or with each other. Thus, in order to align the signal center longitudinal axes C_{SA} and C_{SB} respectively to the hub center longitudinal axes C_{HA} and C_{HB}, lots of trial and error and/or specialized equipment are required. This is typically difficult to accomplish, time-consuming, expensive, and complicates the manufacturing of optical discs.

Thus, there is a need for an improved method of aligning the signal center longitudinal axis with the hub center longitudinal axis of the optical disc.

### SUMMARY OF THE INVENTION

An optical disc according to an embodiment of the invention includes a first substrate having a first central opening, a first signal layer formed on one of the surfaces of the first substrate, a second substrate having a second central opening, a second signal layer formed on one of the surfaces of the second substrate, and a hub having a central longitudinal axis. The first substrate and the first signal layer are designed such that a first central longitudinal axis of the first opening substantially coaxially aligns with a first central longitudinal axis of the first signal layer, and the second substrate and the second signal layer are designed such that a second central longitudinal axis of the second opening substantially coaxially aligns with a second central longitudinal axis of the second signal layer. The first substrate, the second substrate and the hub are bonded together with the result of substantially coaxially alignment of the central longitudinal axis of the first signal layer, the second signal layer and the hub.

A thickness of the first substrate and a thickness of the second substrate can be substantially same.

A thickness of the first substrate can also be less than a thickness of the second substrate. For example, the thickness of the first substrate is between 0.05 mm and 0.2 mm, and the thickness of the second substrate is greater than 0.3 mm.

The hub may comprise a magnetic material or a magnetic sensitive material.

The signal layer may comprise a recordable material such as a phase change material.

### BRIEF DESCRIPTION OF THE DRAWINGS

FIGS. 1 illustrates a cross-sectional view of a prior art optical disc;

FIG. 2A illustrates a cross-sectional view of an exploded exemplary optical disc in accordance with embodiment 1 of the invention;

FIG. 2B illustrates a cross-sectional view of an assembled exemplary optical disc in accordance with embodiment 1 of the invention;

FIG. 3A illustrates a cross-sectional view of an exploded exemplary optical disc in accordance with embodiment 2 of the invention;

FIG. 3B illustrates a cross-sectional view of an assembled exemplary optical disc in accordance with embodiment 2 of the invention.

FIG. 4A illustrates a cross-sectional view of an exploded exemplary optical disc in accordance with embodiment 3 of the invention;

FIG. 4B illustrates a cross-sectional view of an assembled exemplary optical disc in accordance with embodiment 3 of the invention;

FIG. 5A illustrates a cross-sectional view of an exploded exemplary optical disc in accordance with embodiment 4 of the invention; and

FIG. 5B illustrates a cross-sectional view of an assembled exemplary optical disc in accordance with embodiment 4 of the invention.

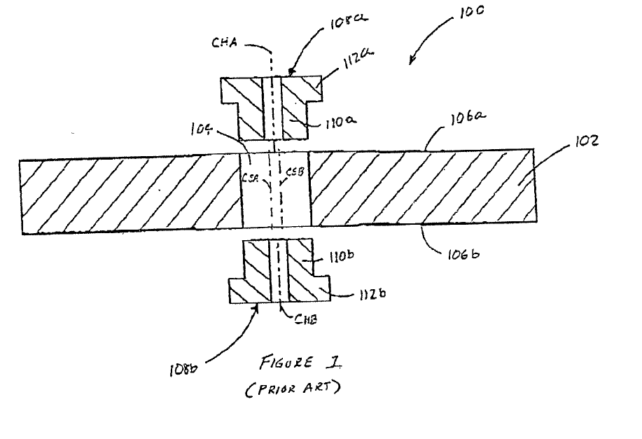

### DETAILED DESCRIPTION OF THE INVENTION

(Embodiment 1)

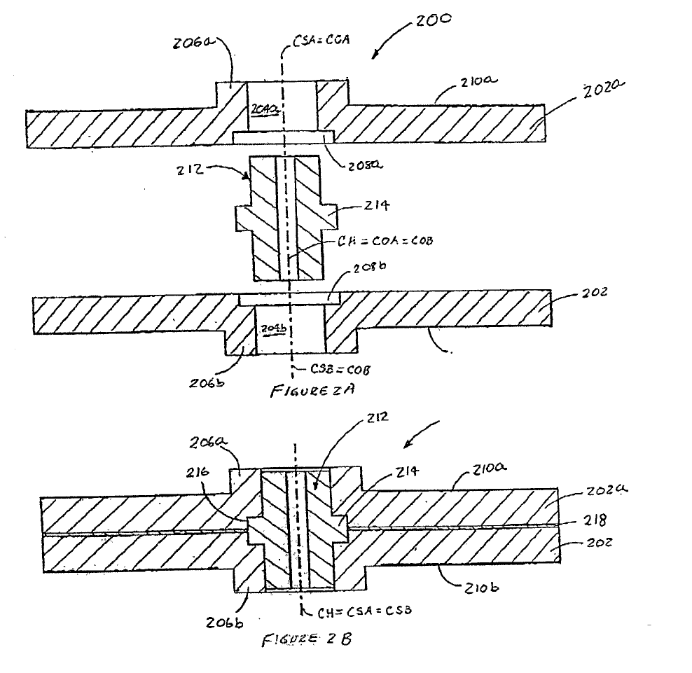

FIG. 2A illustrates a cross-sectional view of an exploded exemplary optical disc 200 in accordance with embodiment 1 of the invention. The optical disc 200 comprises an upper disc-shaped substrate 202a with an upper central opening 204a. The upper substrate 202a comprises an upper annular protrusion 206a extending above the top surface of the upper substrate 202a, and defining the boundary of the upper central opening 204a. In addition, the upper substrate 202a comprises an annular notch 208a located at the bottom surface and coaxial with the central opening 204a of the upper substrate 202a. The upper central opening 204a has a central longitudinal axis C_{OA}.

The optical disc 200 comprises a lower disc-shaped substrate 202b with a lower central opening 204b. The lower substrate 202b comprises a lower annular protrusion 206b extending below the lower surface of the lower substrate 202b, and defining the boundary of the lower central opening 204b. In addition, the lower substrate 204b comprises an annular notch 208b located at the top surface and coaxial with the central opening 204b of the lower substrate 202b. The lower central opening 202b has a central longitudinal axis C_{OB}.

The optical disc 200 of the invention further comprises an upper signal layer 210a formed on the upper surface of the upper substrate 202a, and a lower signal layer 210b formed on the lower surface of the lower substrate 202b. The upper signal layer 210a has a central longitudinal axis C_{SA}, and the lower signal layer 210b has a central longitudinal axis C_{SB}. Additionally, the optical disc 200 comprises a cylindrical hub 212 having an annular protrusion 214 extending outwardly from the outer cylindrical wall of the hub 212. The annular protrusion 214 is centrally located along the cylindrical wall of the hub 212. The cylindrical hub 212 has a central longitudinal axis C_{H}.

FIG. 2B illustrates a cross-sectional view of the assembled exemplary optical disc 200 in accordance with embodiment 1 of the invention. Assembled, the lower surface of the upper substrate 202a is attached to the upper surface of the lower substrate 202b using an adhesive 218. The attachment of the upper substrate 202a to the lower substrate 202b forms an annular groove 216 by the mating of the upper annular notch 208a to the lower annular notch 208b. The annular protrusion 214 of the hub 212 registers within the annular groove 216. The length of the annular protrusion 214 of the hub 212 is smaller than the depth of the annular groove 216 so that the outer cylindrical wall of the hub 212 are flushed with the walls of the central openings 204a-b.

The following explains the method of aligning the central longitudinal axes C_{SA} and C_{SB} of the upper and lower signal layers 210a-b to the central longitudinal axis C_{H} of the hub 212 in accordance with the invention. The upper substrate 202a and the upper signal layer 210a are designed such that the central longitudinal axis C_{SA} of the upper signal layer 210a coaxially aligns with the central longitudinal axis C_{OA} of the upper central opening 204a of the upper substrate 202a. Also, the lower substrate 202b and the lower signal layer 210b are designed such that the central longitudinal axis C_{SB} of the lower signal layer 210b coaxially aligns with the central longitudinal axis C_{OB} of the lower central opening 204b of the lower substrate 202b.

The hub 212, having its outer cylindrical wall flushed with the walls of the upper and lower central openings 204a-b, has a central longitudinal axis C_{H} that is coaxially aligned with the central longitudinal axes C_{OA} and C_{OB} of the upper and lower central openings 204a-b. Since the central longitudinal axes C_{SA} and C_{SB} of the upper and lower signal layers 210a-b coaxially align with the central longitudinal axes C_{OA} and C_{OB} of the upper and lower central openings 204a-b, it follows that the central longitudinal axes C_{SA} and C_{SB} of the upper and lower signal layers 210a-b are coaxially aligned with the central longitudinal axis C_{H} of the hub 212. This condition allows for proper reading of the signal layers 210a-b by an optical disc reader.

(Embodiment 2)

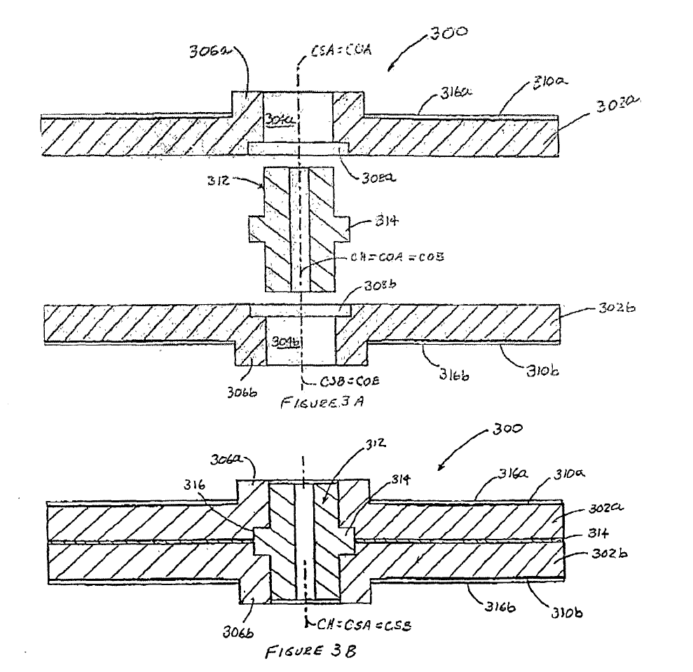

FIGS. 3A-B illustrate respective cross-sectional views of an exploded and assembled exemplary optical disc 300 in accordance with embodiment 2 of the invention. The optical disc 300 is the same as the optical disc 200, except that protective layers 316a-b cover respectively the upper and lower signal layers 310a-b.

(Embodiment 3)

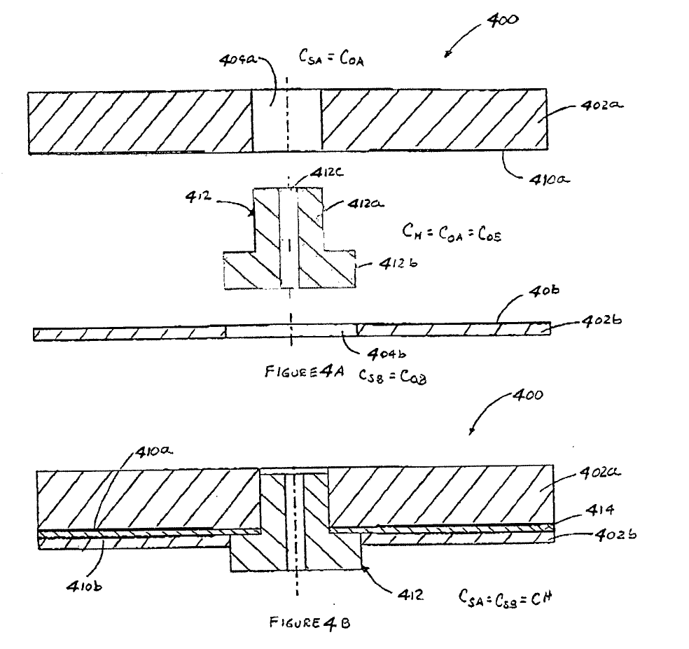

FIG. 4A illustrates a cross-sectional view of an exploded exemplary optical disc 400 in accordance with embodiment 3 of the invention. The optical disc 400 comprises an upper disc-shaped substrate 402a with an upper central opening 404a. In the exemplary embodiment, the thickness of the upper substrate 402a is greater than approximately 0.3 mm. The upper central opening 404a has a central longitudinal axis C_{OA}. The upper substrate 402a further comprises an upper signal layer 410a formed on the lower surface of the upper substrate 402a. The upper signal layer 410a spirals around a central longitudinal axis C_{SA}.

The optical disc 400 further comprises a lower disc-shaped substrate 402b with a lower central opening 404b. In the exemplary embodiment, the thickness of the lower substrate 402b is approximately 0.05 to 0.2 mm. The lower central opening 402b has a central longitudinal axis C_{OB}. The lower substrate 402b further comprises a lower signal layer 410b formed on the upper surface of the lower substrate 402b. The lower signal layer 410b spirals around a central longitudinal axis C_{SB}.

Additionally, the optical disc 400 comprises a hub 412 having an upper cylindrical portion 412a and a lower cylindrical portion 412b. In the exemplary embodiment, the diameter of the outer walls of the lower cylindrical portion 412b is greater than the diameter of the outer walls of the upper cylindrical portion 412a. The hub further includes a thru-opening 412c that extends longitudinally and coaxially through the upper and lower cylindrical portions 412a and 412b of the hub 412. The central longitudinal axis of the hub 412 can be represented as C_{H}.

FIG. 4B illustrates a cross-sectional view of the assembled exemplary optical disc 400 in accordance with the invention. Assembled, the lower surface of the upper substrate 402a is attached to the upper surface of the lower substrate 402b using an adhesive 414. Also assembled, the upper cylindrical portion 412a of the hub 412 extends coaxially within the opening 404a of the upper substrate 402a. Additionally, the lower cylindrical portion 412b of the hub 412 extends coaxially within and below the opening 404b of the lower substrate 402b.

The following explains the method of aligning the central longitudinal axes C_{SA} and C_{SB} of the upper and lower signal layers 410a-b to the central longitudinal axis C_{H} of the hub 412 in accordance with the invention. The upper substrate 402a and the upper signal layer 410a are designed such that the central longitudinal axis C_{SA} of the upper signal layer 410a substantially coaxially aligns with the central longitudinal axis C_{OA} of the upper central opening 404a of the upper substrate 402a. Also, the lower substrate 402b and the lower signal layer 410b are designed such that the central longitudinal axis C_{SB} of the lower signal layer 410b substantially coaxially aligns with the central longitudinal axis C_{OB} of the lower central opening 404b of the lower substrate 402b. These substantially coaxial relations C_{SA}=C_{OA} and C_{SB}=C_{OB} can be easily obtained by regular molding of substrates, similar to current CD, DVD, and MD molding processes.

The hub 412, having its upper and lower cylindrical portions 412a-b flushed with the walls of the upper and lower central openings 404a-b, has a central longitudinal axis C_{H} that is substantially coaxially aligned with the central longitudinal axes C_{OA} and C_{OB} of the upper and lower central openings 404a-b. Since the central longitudinal axes C_{SA} and C_{SB} of the upper and lower signal layers 410a-b substantially coaxially align with the central longitudinal axes C_{OA} and C_{OB} of the upper and lower central openings 404a-b, it follows that the central longitudinal axes C_{SA} and C_{SB} of the upper and lower signal layers 410a-b are substantially coaxially aligned with the central longitudinal axis C_{H} of the hub 412. This condition allows for proper reading of the signal layers 410a-b by an optical disc reader.

(Embodiment 4)

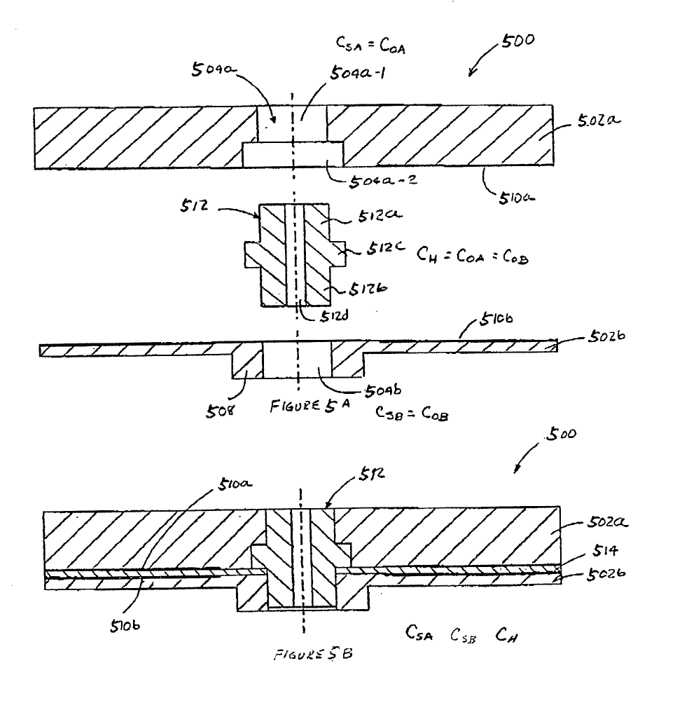

FIG. 5A illustrates a cross-sectional view of an exploded exemplary optical disc 500 in accordance with embodiment 4 of the invention. The optical disc 500 comprises an upper disc-shaped substrate 502a with an upper central opening 502a having an upper portion 504a-1 and a lower portion 504a-2. In the exemplary embodiment, the diameter of the upper portion 504a-1 is less than the diameter of the lower portion 504a-2 of the upper central opening 504a. The upper central opening 502a has a central longitudinal axis C_{OA}. Also in the exemplary embodiment, the thickness of the upper substrate 502a is greater than approximately 0.3 mm. The upper substrate 502a further comprises an upper signal layer 510a formed on the lower surface of the upper substrate 502a. The upper signal layer 510a spirals around a central longitudinal axis C_{SA}.

The optical disc 500 further comprises a lower disc-shaped substrate 502b with a lower central opening 504b. In the exemplary embodiment, the thickness of the lower substrate 502b is approximately 0.05 to 0.2 mm. The lower central opening 502b has a central longitudinal axis C_{OB}. The lower substrate 502b includes an annular protrusion 508 that extends below the lower surface of the lower substrate 502b and defines a lower portion of the central opening 504b. In addition, the lower substrate 502b further comprises a lower signal layer 510b formed on the upper surface of the lower substrate 502b. The lower signal layer 510b spirals around a central longitudinal axis C_{SB}.

Additionally, the optical disc 500 comprises a hub 512 having an upper cylindrical portion 512a, a lower cylindrical portion 512b, and a middle cylindrical portion 512c. In the exemplary embodiment, the diameter of the outer walls of the middle cylindrical portion 512c is greater than the diameters of the outer walls of the lower and upper cylindrical portion 512a-b, which are substantially the same. The hub further includes a thru-opening 512d that extends longitudinally and coaxially through the upper, lower, and middle cylindrical portions 512a-c of the hub 512. The central longitudinal axis of the hub 512 can be represented as C_{H}.

FIG. 5B illustrates a cross-sectional view of the assembled exemplary optical disc 300 in accordance with embodiment 4 of the invention. Assembled, the lower surface of the upper substrate 502a is attached to the upper surface of the lower substrate 502b using an adhesive 514. Also assembled, the upper cylindrical portion 512a of the hub 512 extends coaxially within the upper portion 504a-1 of the upper central opening 504a of the upper substrate 502a. The middle cylindrical portion 512c of the hub 512 extends coaxially within the lower portion 504a-2 of the upper central opening 504a of the upper substrate 502a. Additionally, the lower cylindrical portion 512b of the hub 512 extends coaxially within the opening 504b of the lower substrate 502b.

The following explains the method of aligning the central longitudinal axes C_{SA} and C_{SB} of the upper and lower signal layers 510a-b to the central longitudinal axis C_{H} Of the hub 512 in accordance with the invention. The upper substrate 502a and the upper signal layer 510a are designed such that the central longitudinal axis C_{SA} of the upper signal layer 510a substantially coaxially aligns with the central longitudinal axis C_{OA} of the upper central opening 504a of the upper substrate 502a. Also, the lower substrate 502b and the lower signal layer 510b are designed such that the central longitudinal axis C_{SB} of the lower signal layer 510b substantially coaxially aligns with the central longitudinal axis C_{OB} of the lower central opening 504b of the lower substrate 502b. These substantially coaxial relations C_{SA}=C_{OA} and C_{SB}=C_{OB} can be easily obtained by regular molding of substrates, similar to current CD, DVD, and MD molding processes.

The hub 512, having its upper and middle cylindrical portions 512a and 512c flushed with the walls of the upper and lower portions 504a-1-2 of the upper central openings 504a, has a central longitudinal axis C_{H} that is coaxially aligned with the central longitudinal axis C_{OA} of the upper central opening 504a. Also, the hub 512, having its lower cylindrical portion 512b flushed with the wall of the lower central opening 504b, has its central longitudinal axis C_{H} coaxially aligned with the central longitudinal axis C_{OB} of the lower central opening 504b. Since the central longitudinal axes C_{SA} and C_{SB} of the upper and lower signal layers 510a-b coaxially align with the central longitudinal axes C_{OA} and C_{OB} of the upper and lower central openings 504a-b, it follows that the central longitudinal axes C_{SA} and C_{SB} of the upper and lower signal layers 510a-b are coaxially aligned with the central longitudinal axis C_{H} of the hub 512. This condition allows for proper reading of the signal layers 510a-b by an optical disc reader.

In the exemplary optical discs 200, 300, 400 and 500, the substrates may be formed of a polycarbonate, the hub is formed of a magnetically-sensitive metal, the adhesive is formed of a bonding resin, such as a ultraviolet curing resin, the signal layers are formed of a reflective layer, such as a phase change material (Te—Ge—Sb), and the protective layer is formed of a ultraviolet curing resin with lower viscosity. The optical disc 200, 300, 400 or 500 can be a compact disc (CD), a digital versatile disc (DVD), a micro disc (MD), a Data Play disc, or other format. These discs can be formed by a molding process or by a stamping process. If a molding process is used, the discs can be removed from the molding fixture using an air ejection process.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. An optical disc comprising:
a first substrate having a first central opening centered about a first central longitudinal axis;
a first signal layer formed on one of the surfaces of the first substrate, wherein the first signal layer spirals about a second central longitudinal axis;
a second substrate having a second central opening centered about a third central longitudinal axis;
a second signal layer formed on one of the surfaces of the second substrate, wherein the second signal layer spirals about a fourth central longitudinal axis; and
a hub having a fifth central longitudinal axis, wherein the first central longitudinal axis of the first central opening of the first substrate substantially coaxially aligns with the second central longitudinal axis of the first signal layer, wherein the third central longitudinal axis of the second central opening of the second substrate substantially coaxially aligns with the fourth central longitudinal axis of the second signal layer, and wherein the first substrate, the second substrate, and the hub are bonded together such that the second, fourth, and fifth central longitudinal axes respectively of the first signal layer, the second signal layer and the hub are substantially coaxial.

2. The optical disc according to claim 1, wherein a thickness of the first substrate and the second substrate are substantially the same.

3. The optical disc according to claim 1, wherein a thickness of the first substrate is less than a thickness of the second substrate.

4. The optical disc according to claim 3, wherein the thickness of the first substrate is between about 0.05 millimeter to about 0.2 millimeter, and the thickness of the second substrate is greater than about 0.3 millimeter.

5. The optical disc according to claim 1, wherein the hub comprises a magnetic material.

6. The optical disc according to claim 1, wherein the hub comprises a magnetic sensitive material.

7. The optical disc according to claim 1, wherein the signal layer comprises a recordable material comprising a phase change material.

8. A method comprising:
forming a first substrate having a first central opening centered about a first central longitudinal axis;
forming a first signal layer on the first substrate, wherein the first signal layer spirals about a second central longitudinal axis, and wherein the first central longitudinal axis of the first central opening of the first substrate substantially coaxially aligns with the second central longitudinal axis of the first signal layer;
forming a second substrate having a second central opening centered about a third central longitudinal axis;
forming a second signal layer formed on the second substrate, wherein the second signal layer spirals about a fourth central longitudinal axis, and wherein the third central longitudinal axis of the second central opening of the second substrate substantially coaxially aligns with the fourth central longitudinal axis of the second signal layer;
forming a hub having a fifth central longitudinal axis; and
assembling the first substrate, the second substrate, and the hub together such that the second, fourth, and fifth central longitudinal axes respectively of the first signal layer, the second signal layer and the hub are substantially coaxial.

9. The method according to claim 8, wherein a thickness of the first substrate and the second substrate are substantially the same.

10. The method according to claim 8, wherein a thickness of the first substrate is less than a thickness of the second substrate.

11. The method according to claim 10, wherein the thickness of the first substrate is between about 0.05 millimeter to about 0.2 millimeter, and the thickness of the second substrate is greater than about 0.3 millimeter.

12. The method according to claim 8, wherein the hub comprises a magnetic material.

13. The method according to claim 8, wherein the hub comprises a magnetic sensitive material.

14. The method according to claim 8, wherein the signal layer comprises a recordable material comprising a phase change material.

15. A data storage disc comprising:
a first substrate having a first central opening centered about a first central longitudinal axis;
a first data layer formed on one of the surfaces of the first substrate, wherein the first data layer spirals about a second central longitudinal axis;
a second substrate having a second central opening centered about a third central longitudinal axis;
a second data layer formed on one of the surfaces of the second substrate, wherein the second data layer spirals about a fourth central longitudinal axis; and
a hub having a fifth central longitudinal axis, wherein the first central longitudinal axis of the first central opening of the first substrate substantially coaxially aligns with the second central longitudinal axis of the first data layer, wherein the third central longitudinal axis of the second central opening of the second substrate substantially coaxially aligns with the fourth central longitudinal axis of the second data layer, and wherein the first substrate, the second substrate, and the hub are bonded together such that the second, fourth, and fifth central longitudinal axes respectively of the first data layer, the second data layer and the hub are substantially coaxial.

16. The data storage disc according to claim 15, wherein a thickness of the first substrate and the second substrate are substantially the same.

17. The data storage disc according to claim 15, wherein a thickness of the first substrate is less than a thickness of the second substrate.

18. The data storage disc according to claim 17, wherein the thickness of the first substrate is between about 0.05 millimeter to about 0.2 millimeter, and the thickness of the second substrate is greater than about 0.3 millimeter.

19. The data storage disc according to claim 15, wherein the hub comprises a magnetic material.

20. The data storage disc according to claim 15, wherein the hub comprises a magnetic sensitive material.

21. The data storage disc according to claim 15, wherein the signal layer comprises a recordable material comprising a phase change material.
